(19) United States
(12) Patent Application Publication
(10) Pub. No.: US 2010/0004036 A1
(43) Pub. Date: Jan. 7, 2010

(54) MOBILE PHONE HAVING FULL KEYBOARD

(75) Inventor: QING-HUA LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/327,906

(22) Filed: Dec. 4, 2008

(30) Foreign Application Priority Data
Jul. 4, 2008 (CN) 200810302542.9

(51) Int. Cl. H04M 1/00; G06F 3/02

(52) U.S. Cl. 455/575.1; 345/169; 341/22; 455/566

(57) ABSTRACT

A mobile phone includes a main body having a front side and a rear side. A full keyboard is formed on the rear side of the main body, and a screen is pivotally attached to the front side of the main body. The screen includes a display surface and a back surface. The display surface is opposite to the full keyboard when the screen is in a closed state, and the display surface and the full keyboard substantially face a same direction when the screen is in an open state.

### BACKGROUND

1. Technical Field

The present disclosure relates to mobile phones with full keyboards.

2. General Background

Mobile phones are popular communication devices. Some mobile phones integrate physical keyboards and screens on one surface of the mobile phones. However, the screens and the keyboards of these mobile phones are small and difficult to use. Some mobile phones have adopted full keyboards to input keys. However, full keyboards have more keys than typical mobile phone keyboards and are not compact.

What is needed, therefore, is a compact and light mobile phone having a relatively large screen and full keyboard.

### BRIEF DESCRIPTION OF THE DRAWINGS

FIG. 1 is an isometric view of one embodiment of a mobile phone when a screen of the mobile phone is closed.

FIG. 2 is an isometric view of one embodiment of the mobile phone when the screen is open.

FIG. 3 is similar to FIG. 1, but viewed from another aspect.

FIG. 4 is similar to FIG. 2, but viewed from another aspect.

### DETAILED DESCRIPTION OF THE EMBODIMENTS

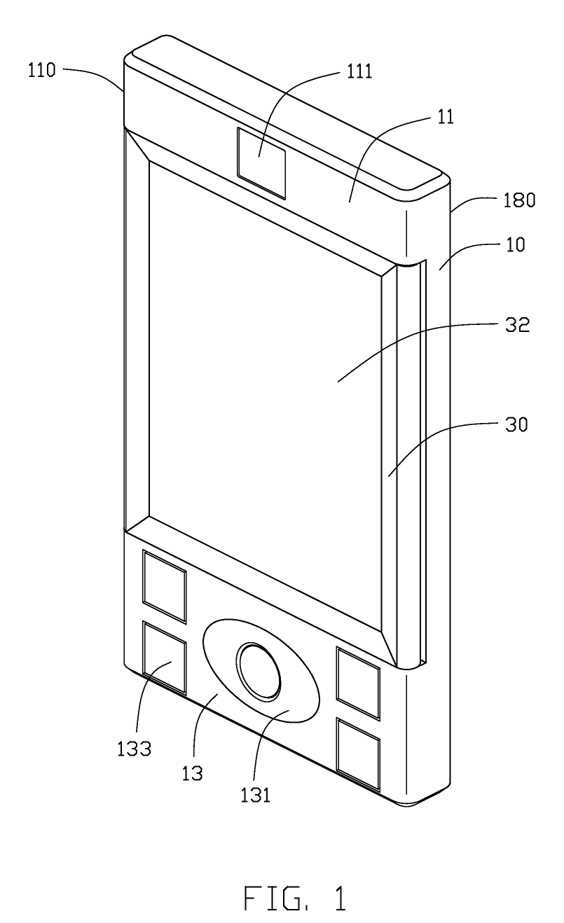

Referring to FIG. 1, one embodiment of a mobile phone having a full keyboard includes a main body 10 and a screen 30 pivotally attached to the main body 10. The full keyboard includes twenty-six alpha letter keys and ten number keys similar to a computer keyboard. The full keyboard may further include a delete key, an enter key, a space key, and other keys found in a computer keyboard.

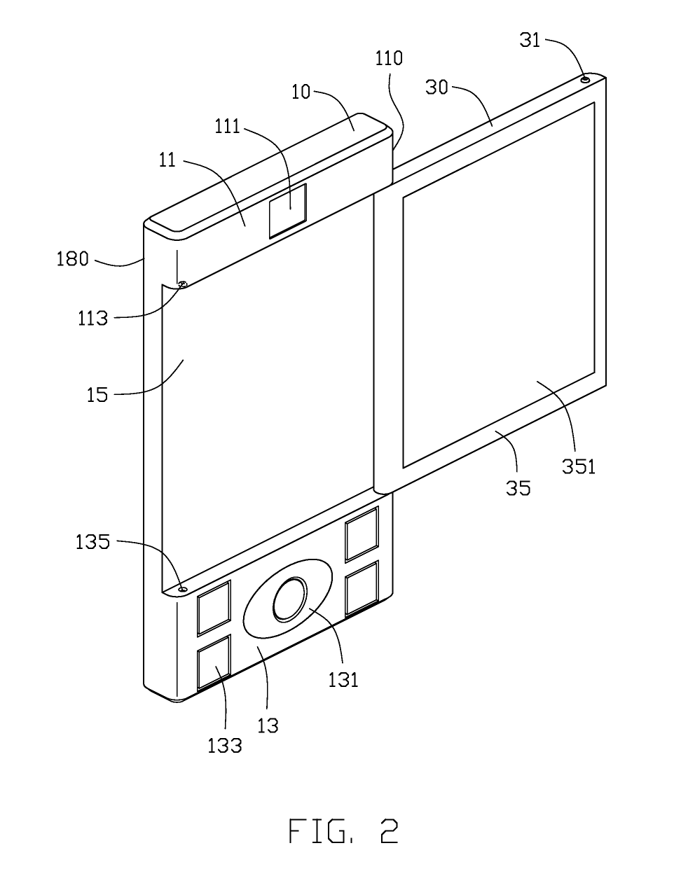

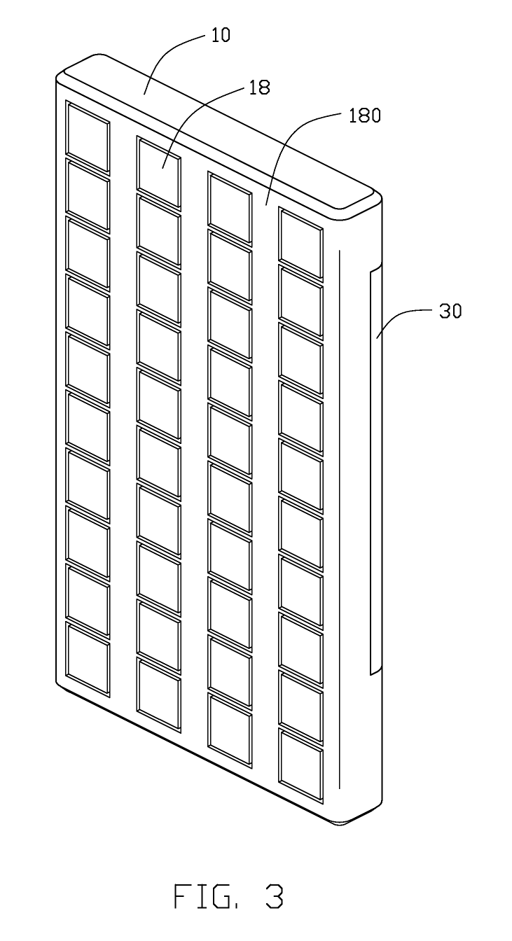

Referring also to FIGS. 2 and 3, the main body 10 has a front side 110 and a rear side 180. A listening portion 11 is formed at an upper portion of the front side 110. A speaker portion 111 is positioned at a center part of the listening portion 11. A first keyboard portion 13 is formed at a lower portion of the front side 110. A navigational key 131 is disposed at a center part of the first keyboard portion 13. Function keys 133 are positioned on the first keyboard portion 13 around the navigational key 131. A recessed portion 15 is defined between the listening portion 11 and the first keyboard portion 13 for receiving the screen 30. A depth of the recessed portion 15 is substantially equal to the thickness of the screen 30. Two positioning holes 113 and 135 are respectively defined in a bottom side of the listening portion 11 and a top side of the first keyboard portion 13. A full keyboard 18 is positioned and substantially occupies the rear side 180 of the main body 10.

One side of the screen 30 is pivotably secured to one side of the main body 10 between the listening portion 11 and the first keyboard portion 13. The screen 30 is electrically connected to the main body 10 of the mobile phone. Two positioning posts 31 respectively protrude from a top side and a bottom side of the screen 30 corresponding to the positioning holes 113, 135. The screen 30 has a display surface 32 and a back surface 35. When the screen 30 is closed, the screen 30 is received in the recessed portion 15 of the main body 10 of the mobile phone. The display surface 32 of the screen 30 is aligned with the listening portion 11 and the first keyboard portion 13 to form a substantially smooth plane. The positioning posts 31 of the screen 30 are engaged in the positioning holes 113 and 135 in the listening portion 11 and the first keyboard portion 13 to prevent accidental opening of the screen 30. A mirror 351 may be adhered to the back surface 35 of the screen 30 to provide additional functionality to the mobile phone when the screen 30 is open. In other embodiments, the positioning structure of the positioning posts 31 and the positioning holes 113, 135 can be replaced by other similar structures. The mirror 351 may also be replaced by a photo clip or a planar structure.

In use, simple operations such as viewing messages, answering phone calls, and calling phone numbers from an address list in the mobile phone may only require the function keys 133 and navigational key 131. Therefore, the screen 30 of the mobile phone may be closed when the above operation is done.

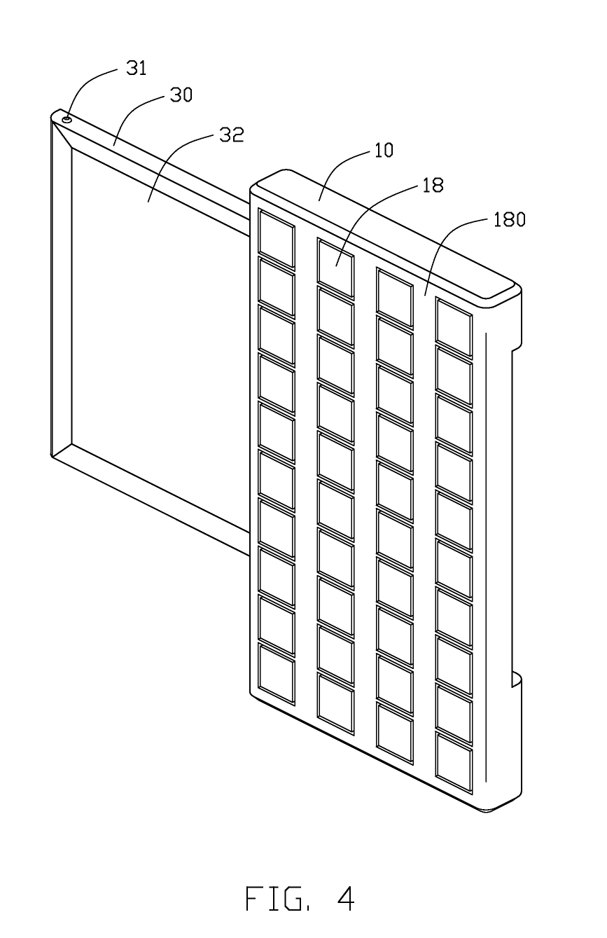

Referring to FIG. 4, when users need to input information, such as entering messages by using the full keyboard 18, the screen 30 is opened and rotated to align with the full keyboard 18. Thus, the display surface 32 of the screen 30 and the keyboard 18 are conveniently located on a same plane.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A mobile phone, comprising:
a main body having a front side and a rear side, wherein a full keyboard is formed on the rear side of the main body; and
a screen pivotally attached to the front side of the main body, the screen having a display surface and a back surface, wherein the display surface is opposite to the full keyboard when the screen is in a closed state, and the display surface and the full keyboard substantially face a same direction when the screen is in an open state.

2. The mobile phone of claim 1, wherein the main body of the mobile phone comprises a listening portion and a first keyboard portion; the screen is pivotally attached to the main body between the listening portion and the first keyboard portion.

3. The mobile phone of claim 2, wherein the screen comprises a pivot side pivotally attached to one side of the main body and a positioning side secured to an opposite side of the main body; two positioning posts protrude from the positioning side of the screen; two positioning holes corresponding to the positioning posts are respectively defined in the listening portion and the first keyboard portion.

4. The mobile phone of claim 2, wherein a recess portion is defined between the listening portion and the first keyboard portion for receiving the screen.

5. The mobile phone of claim 4, wherein the depth of the recess portion is substantially equal to the thickness of the screen so that the display surface of the screen is substantially coplanar with the listening portion and the first keyboard portion when the screen is in the closed state.

6. The mobile phone of claim 5, wherein the back surface of the screen abuts against the recess portion of the main body when the screen is in the closed state; a planar additional component is adhered to the back surface of the screen.

7. An electronic device, comprising:
a main body having a front side and a rear side, wherein a full keyboard is formed on the rear side of the main body; and
a screen pivotally attached to the front side of the main body, wherein the screen is rotatable between a first position where the screen is opposite to the full keyboard of the main body and a second position where the screen and the full keyboard face a same direction.

8. The electronic device of claim 7, wherein the main body of the electronic device comprises a listening portion and a first keyboard portion; the screen is pivotally attached to the main body between the listening portion and the first keyboard portion.

9. The electronic device of claim 8, wherein the screen comprises a pivot side pivotally attached to one side of the main body and a positioning side secured to an opposite side of the main body; two positioning posts protrude from the positioning side of the screen, and two positioning holes corresponding to the positioning posts are respectively defined in the listening portion and the first keyboard portion.

10. The electronic device of claim 8, wherein a recess portion is defined between the listening portion and the first keyboard portion for receiving the screen.

11. The electronic device of claim 10, wherein the screen comprises a display surface and a back surface; the depth of the recess portion is substantially equal to the thickness of the screen so that the display surface of the screen is substantially coplanar with the listening portion and the first keyboard portion when the screen is in the first position. 12. The electronic device of claim 11, wherein the back surface of the screen abuts against the recess portion of the main body when the screen is in the first position; a planar additional component is adhered to the back surface of the screen.
